(19) United States
(12) Patent Application Publication
(10) Pub. No.: US 2023/0378756 A1
(43) Pub. Date: Nov. 23, 2023

(54) LARGE SCALE ENERGY STORAGE WITH AI-BASED GRADING AND EFFICIENCY ASSESSMENT

(71) Applicant: Our Next Energy, Inc., Novi, MI (US)

(72) Inventors: Mujeeb Ijaz, West Bloomfield, MI (US); Deeana Ijaz, Novi, MI (US); Shazad Butt, Novi, MI (US)

(21) Appl. No.: 18/320,942

(22) Filed: May 19, 2023

Related U.S. Application Data
(60) Provisional application No. 63/344,464, filed on May 20, 2022.
(60) Provisional application No. 63/344,465, filed on May 20, 2022.
(60) Provisional application No. 63/344,466, filed on May 20, 2022.

(51) Int. Cl. H02J 3/32; H02J 3/38

(52) U.S. Cl. CPC H02J 3/32; H02J 3/381; H02J 2203/20

(57) ABSTRACT

A large-scale energy storage facility that includes autonomous energy storage towers for housing cells in a manufacturing stage. Electrical energy is selectively stored in the cells from an energy source or grid as reserve energy by providing. This is performed during an inventorying stage of a manufacturing process of the cells. The energy storage includes a charge cycle that is exploited in a quality assessment process of the cells. The energy is selectively retrieved for provision back to the grid or energy source in a discharge cycle which is also exploited for quality assessment of the cells. A highly energy efficient and cost-effective framework is thus obtained from the architecture.

### TECHNICAL FIELD

The present disclosure relates generally to a large-scale energy storage facility, battery grading using AI-based techniques, and efficiency assessment and control of power systems using AI-based techniques, some or all of which may be used individually or in conjunction with one another.

### BACKGROUND

Electric power is typically obtained from one or more primary power generation sources, such as gas-fired, coal-fired, nuclear, and/or hydroelectric power plants, and delivered to users via a distribution grid. The amount of electricity provided by these sources and the demand placed on them may change at any time. These sources may be controlled to satisfy consumer demands while also adhering to industry standards for power, such as nominal voltage and frequency levels.

Backup energy storage systems may be used to supplement power supplied by the primary power generation sources during peak load or high demand periods, disruptions such as power interruptions from primary power generation sources or transmission constraints during normal operations, a power generator going offline, or to augment intermittent or variable power sources, among other things.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a block diagram of power delivery environment illustrating a network of systems in which illustrative embodiments may be implemented.

FIG. 2 depicts a block diagram of a data processing system in which illustrative embodiments may be implemented.

FIG. 3 depicts a factory to grid process in which illustrative embodiments may be implemented.

FIG. 4 depicts another factory to grid process in which illustrative embodiments may be implemented.

FIG. 5 depicts a sketch of an energy storage tower in which illustrative embodiments may be implemented.

FIG. 6 depicts a sketch of another energy storage tower in which illustrative embodiments may be implemented.

FIG. 7 depicts a system block diagram of energy storage towers in which illustrative embodiments may be implemented.

FIG. 8 depicts a system block diagram of another energy storage tower in which illustrative embodiments may be implemented.

FIG. 9 is a flowchart depicting a process in which illustrative embodiments may be implemented.

FIG. 10 is a flowchart depicting another process in which illustrative embodiments may be implemented.

FIG. 11 depicts a block diagram of a machine learning configuration in which illustrative embodiments may be implemented.

FIG. 12 depicts some types of operational efficiency enhancement proposals in which illustrative embodiments may be implemented.

FIG. 13 depicts a block diagram of a training architecture in which illustrative embodiments may be implemented.

FIG. 14 illustrates a process 1400 in accordance with one embodiment.

FIG. 15 depicts a block diagram of an example prioritization of attributes in which illustrative embodiments may be implemented.

### DETAILED DESCRIPTION

The illustrative embodiments recognize that on hand, sustainable, low-cost energy storage systems may be critical in the operation of a power grid. On another hand, demand for electric vehicles (EV) and EV batteries is rapidly increasing, bringing along with it increased cell manufacturing and efficiency requirements. By combining the provision of low-cost battery energy storage systems for a grid with a capacity to manufacture high quality battery cells, in a common architecture, a highly scalable and efficient factory model may be obtained. The illustrative embodiments recognize that a charging and discharging of cells during a cell manufacturing process may usually be confined to just a required minimum number of cycles (e.g., once or twice) due to associated costs and time requirements which may make it impractical to demand more than a standard conventional cell quality. However, by utilizing a framework that combines grid energy storage operations, in which energy may be stored in cells in a charging process and retrieved at a later time in a discharging process, with cell manufacturing operations in which cells in a manufacturing stage may undergo a series of charge-discharge cycles to access cell quality, not only may it be practical to perform much more than just the minimum number of cycles for grading cells, it may be more efficient because the charge-discharge cycles may utilize energy from the grid as opposed to external energy that may otherwise be disposed of as heat. The ability to more accurately determine cell quality may be enhanced and a use of temperature management systems, ventilation systems and air-conditioners to dissipate heat in conventional solutions during discharge cycles may be substantially eliminated due to the saving and re-utilization of energy.

In one aspect, the common architecture may be configured as an energy storage tower which may be autonomous. The autonomous energy storage tower may include a plurality of cells configured as one or more cell arrays having a temporary no-weld architecture which may comprise a temporary cell array electronic circuit to communicate with the cells without permanent physical connection or weld to the cells. The autonomous energy storage tower may also comprise a power conversion module configured to electrically couple the autonomous energy storage tower to a grid and to an energy source, with the power conversion module being configured to, responsive to completion of a SEI (solid electrolyte interface) layer formation process of the cells, receive electrical energy from the energy source and to selectively supply said electrical energy to one or more of the plurality of cells in a charging mode. The power conversion module may also be further configured to, responsive to completion of the SEI layer formation process of the cells, selectively retrieve electrical energy from one or more of the plurality of cells to supply said electrical energy to the grid or the energy source in a discharging mode. By using the temporary no-weld architecture, the cells may be easily removed upon completion of corresponding cell quality assessment procedures (and thus completion of cell manufacturing) and packed into an EV battery pack. Herein, the term grid may be used to generally refer to all types of power grids including a conventional grid and a micro grid.

In another aspect, a large-scale energy storage facility may be disclosed. The large-scale energy storage facility may be a “Gigafactory” and may comprise at least one autonomous energy storage tower. In an embodiment, the large-scale energy storage facility may comprise between 5000-50,000 autonomous energy storage towers and may be configured to store 1-20 GWh of energy.

In another aspect, a method may be disclosed comprising providing the large-scale energy storage facility which may include a plurality of manufacturing stations and selectively storing energy from an energy source as reserve energy by providing to at least one cell of a plurality of cells disposed in one or more energy storage towers the energy from the energy source, said selectively storing step being performed during an inventorying stage of the manufacturing process of the at least one cell by providing the energy as energy for a charge cycle of the at least one cell. The method may further comprise a step of selectively retrieving the reserve energy for provision to a grid or to the energy source by discharging energy from the at least one cell during a discharge cycle, obtaining cell parameter information about the at least one cell during the charge cycle and/or discharge cycle, and grading a quality of the at least one cell during a cell quality assessment process of the inventorying stage based on the obtained cell parameter information.

In an embodiment, utilizing the cells to store and provide energy to the grid while assessing a quality metric of the cells simultaneously may provide significant advantages by way of cost savings. Further, upon determining that the grid no longer needs reserve energy or can't accept extra energy, at least for a period of time, assessing the quality metric of the cells may still be performed through transferring energy bi-directionally in a series of charge-discharge between two groups of cells rather than between cells and the grid/energy source. For example, a first group of selected cells (e.g., 4 million cells) may be discharged in a first operation responsive to which a second group of selected already charged cells (e.g., 4 million previously charged cells) may be used as a source of energy for charging the first group discharged cells. By transferring energy between the first and second group of cells in a plurality of charge-discharge cycles, a quality metric of the cells may be monitored and assessed to grade the cells into one or more performance bins.

In another aspect, an intelligent proposal of one or more battery cell quality enhancement operations may be disclosed. The intelligent proposal may comprise the steps of independently measuring, by at least one cell array controller, parameters of one or more cells of a plurality of cells disposed in a cell array of an energy storage tower; receiving the measured parameters as at least a part of a set of subject large-scale energy storage facility parameters, indicative of one or more characteristics of the large-scale energy storage facility, for use by an efficiency assessment module; generating input data using at least the set of subject large-scale energy storage facility parameters; extracting one or more features from the input data, the one or more features are representative of a characteristic of a request for completing a operational efficiency enhancement proposal operation, and proposing, using the efficiency assessment module, at least one operational efficiency enhancement proposal for the large-scale energy storage facility. The efficiency assessment module may operate as a machine learning engine and may perform several steps including assessing a quality metric of the cells. Thus, the intelligent proposal may maximize cost efficiency by not significantly degrading cells in charge-discharge cycles. Further, should the grid have a need to dispose of a significant amount of energy to the large-scale energy storage facility for storage, the machine learning model may predict such a need and propose beforehand one or more recommendations for operating or manufacturing the cells in the large-scale energy storage facility to accommodate the predicted need. For example, it may be proposed that 1 GWh of storage may be needed in 7 days, for example, due to a forecasted increase in sunlight and thus an increase in the ability of a renewable energy source to provide energy for storage, or due to a forecasted power outage based on an analysis of power outage historic data and/or weather patterns

The architecture and manner of operating cells of the architecture described herein is unavailable in the presently available methods in the technological field of endeavor pertaining to battery energy storage systems and electric vehicles. The term electric vehicle is used hereinafter to collectively refer to vehicles such as motor vehicles, railed vehicles, watercraft and aircraft that are configured to utilize rechargeable electric batteries as their main source of energy to power their drive systems for propulsion. The illustrative embodiments are described with respect to certain types of data, functions, algorithms, equations, model configurations, locations of embodiments, additional data, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a client device, any type of data storage device suitable for use with the client device may provide the data to such embodiment, either locally at the client device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

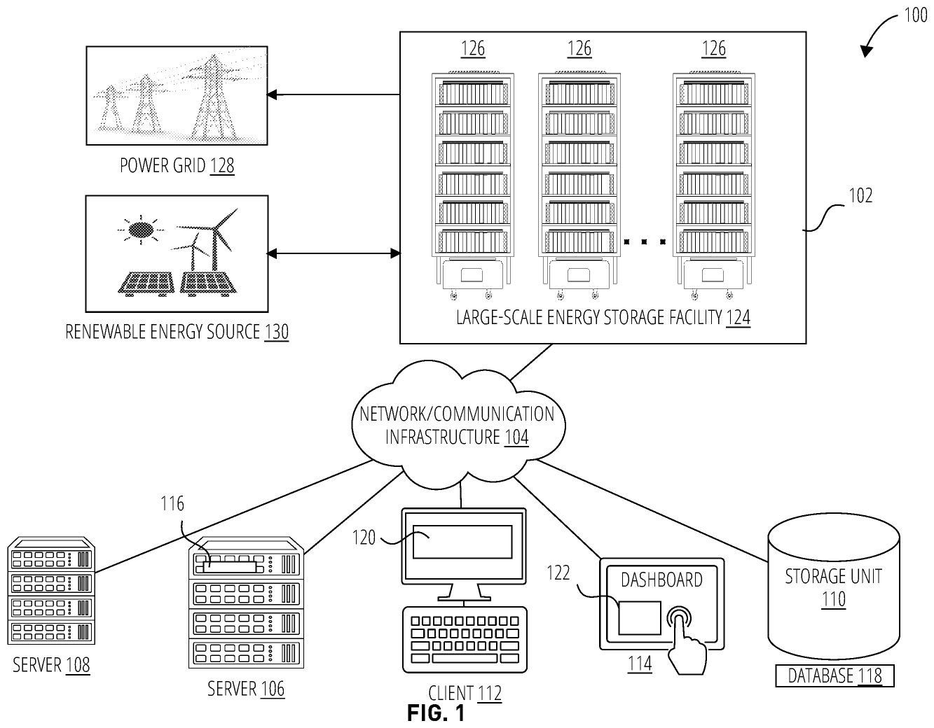

With reference to the figures and in particular with reference to FIG. 1, this figure is an example diagram of a power delivery environments in which illustrative embodiments may be implemented. FIG. 1 is only an example and is not intended to assert or imply any limitation with regard to the environments in which different embodiments may be implemented. A particular implementation may make many modifications to the depicted environments based on the following description.

FIG. 1 depicts a block diagram of a network of systems in which illustrative embodiments may be implemented. Power delivery environment 100 is a network of power delivery systems 102 and computers in which the illustrative embodiments may be implemented. Power delivery environment 100 comprises power grids 128, energy sources such as a renewable energy sources 130, power delivery system 102 and network/communication infrastructure 104. Network/communication infrastructure 104 is the medium used to provide communications links between various devices, databases and computers connected together within power delivery environment 100. Network/communication infrastructure 104 may include connections, such as wire, wireless communication links, or fiber optic cables.

Clients or servers are only example roles of certain data processing systems connected to network/communication infrastructure 104 and are not intended to exclude other configurations or roles for these data processing systems. Server 106 and server 108 couple to network/communication infrastructure 104 along with storage unit 110. Software applications may execute on any computer in power delivery environment 100. Client 112 and dashboard 114 are also coupled to network/communication infrastructure 104. Client 112 may be a remote computer with a display or may even be a mobile device configured with an application to send or receive information, such as to receive a charge condition of the power delivery system 102. Dashboard 114 may be located inside the large-scale energy storage facility and may be configured to send or receive any of the information discussed herein. A data processing system, such as server 106 or server 108, or clients (client 112, dashboard 114) may contain data and may have software applications or software tools executing thereon.

Only as an example, and without implying any limitation to such architecture, FIG. 1 depicts certain components that are usable in an example implementation of an embodiment. For example, servers and clients are only examples and do not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 106, server 108, client 112, dashboard 114) also represent example nodes in a cluster, partitions, and other configurations suitable for implementing an embodiment.

Power delivery system 102 comprises autonomous energy storage towers comprising cell arrays that contain cells that are yet to complete their manufacturing phase. The cells may be charged and discharged for grading purposes and for grid energy storage purposes. As discussed hereinafter, the autonomous energy storage towers may have different forms and may be operated by a mobile drive unit that may be separate from or integrated into the autonomous energy storage tower. The autonomous energy storage tower may have a single cell chemistry or a plurality of different cell chemistries. In one example, cells of the autonomous energy storage tower may have a chemistry that enables prioritizing high energy density applications over high cycle life applications or may have a chemistry that enables prioritizing high cycle life applications over high energy density applications, and each cell array may include a corresponding cell array controller, with quality metrics of each cell of the plurality of cells being independently measurable by a sensor or by the cell array controller.

Prioritizing depletion of energy may be achieved by prioritizing depletion of energy of a cell before extracting energy from another cell. This may enable balancing the needs of power delivery and preservation of charge cycles of said another other cell due to its low cycle life, high energy density chemistry. Prioritizing depletion of cycle life of a cell before extracting cycles from another cell may comprise utilizing the cycle life of high cycle life, low energy density cells before using the cycle life available in low cycle life, high energy density cells. Thus, high energy density cells may best be suited for capacity firming applications wherein high capacity is needed for relatively long-term storage, whereas high cycle life cells may best be suited for high cycling applications such as quality assessment of cells where numerous cycles may be required.

The method may also include prioritizing storing of energy in said at least one other cell before storing energy in the one cell (to provide large storage capacity due to the higher energy density of the one other cell. For the capacity market-capacity firming).

As used herein, the “cycle life” of a battery refers to the number of times the battery may be depleted to 100% depth of discharge (DoD) while still holding at least 80% of its original charge. So, for example, a battery having a cycle life of 100 cycles would hold 80% of its original charge after being charged and completely depleted 100 times. Herein, some cells may be configured for future use, when manufacturing of the cells is concluded, in a high cycle, low energy density traction battery of an electric vehicle and thus a corresponding cell chemistry may be selected to provide a high cycle life of about 3000 cycles (for example, at least 2500 or 3000 cycles). In conventional battery chemistries, this cycle life typically provides a corresponding cell a low energy density of about 400 Wh/L and below. To accommodate a predetermined range requirement for non-traction applications, other cells may also be configured for future use in a range battery, wherein the cell chemistry may be selected to provide, for example, a high energy density of between 1000 and 1100 Wh/L, or above. This typically provides a corresponding low cycle life of about 200 cycles (for example, between 200 and 350 cycles) or less. Depending on the energy requirements of a cells after completion of their manufacturing stage, other chemistries may optionally be configured.

Client application 120, dashboard application 122, or any other application such as server application 116 implements an embodiment described herein. Any of the applications may use data from power delivery system 102 and other sources to compute power or energy requirements. The applications may also obtain data from storage unit 110 for predictive analytics. The applications can also execute in any of data processing systems (server 106 or server 108, client 112, dashboard 114).

Server 106, server 108, storage unit 110, client 112, dashboard 114, may couple to network/communication infrastructure 104 using wired connections, wireless communication protocols, or other suitable data connectivity.

In the depicted example, server 106 may provide data, such as boot files, operating system images, and applications to client 112, and dashboard 114. Client 112, and dashboard 114 may be clients to server 106 in this example. Client 112 and dashboard 114 or some combination thereof, may include their own data, boot files, operating system images, and applications. Power delivery environment 100 may include additional servers, clients, and other devices that are not shown.

Server 108 may include a search engine configured to search information, such as weather condition, grid consumption data, frequency modulation, total energy input into the large-scale energy storage facility, a required cell lifetime at the end of a cell manufacturing stage, a required capacity at the end of a cell manufacturing stage, a maximum cell degradation at the end of a cell manufacturing stage, and a cell chemistry, user feedback, measured cell data, etc., automatically or in response to a request from an operator for power delivery as described herein with respect to various embodiments.

In the depicted example, power delivery environment 100 may be the Internet. Network/communication infrastructure 104 may represent a collection of networks and gateways that use the Transmission Control Protocol/Internet Protocol (TCP/IP), Controller Area Network BUS (CAN bus) and/or other protocols to communicate with one another. At the heart of the Internet is a backbone of data communication links between major nodes or host computers, including thousands of commercial, governmental, educational, and other computer systems that route data and messages. Of course, power delivery environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, power delivery environment 100 may be used for implementing a client-server environment in which the illustrative embodiments may be implemented. A client-server environment enables software applications and data to be distributed across a network such that an application functions by using the interactivity between a client data processing system and a server data processing system. Power delivery environment 100 may also employ a service-oriented architecture where interoperable software components distributed across a network may be packaged together as coherent business applications. Power delivery environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

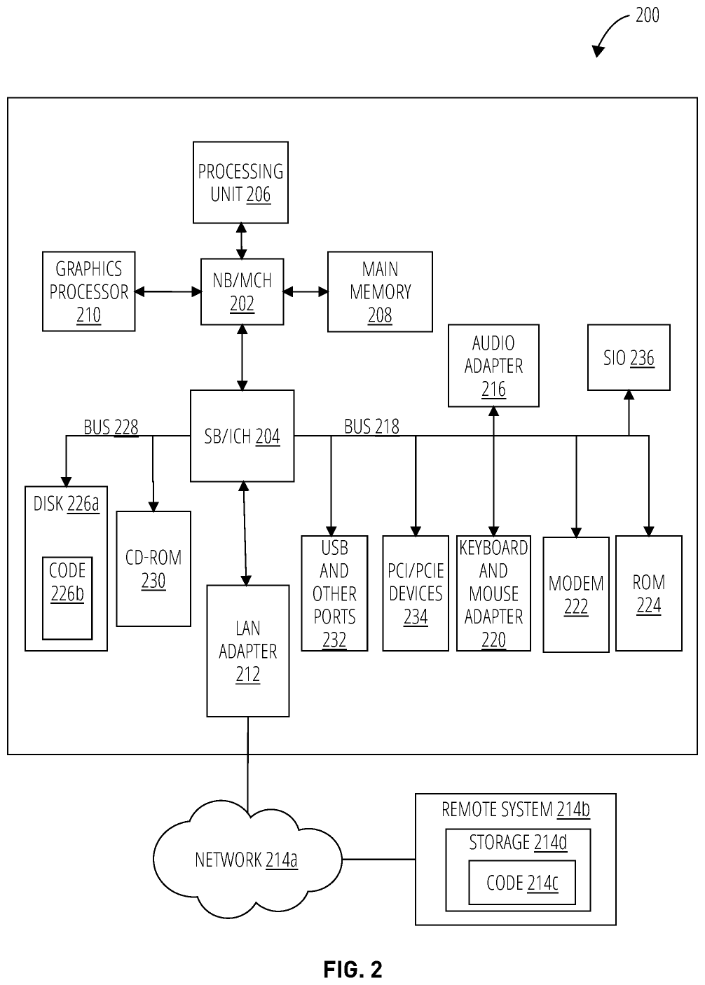

With reference to FIG. 2, this figure depicts a block diagram of a data processing system in which illustrative embodiments may be implemented. Data processing system 200 is an example of a computer, such client 112, dashboard 114, s server 106, or server 108, in FIG. 1, or another type of device in which computer usable program code or instructions implementing the processes may be located for the illustrative embodiments.

Data processing system 200 is described as a computer only as an example, without being limited thereto. Implementations in the form of other devices, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 116 and client application 120 are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

Factory to Grid Process & Energy Storage Tower

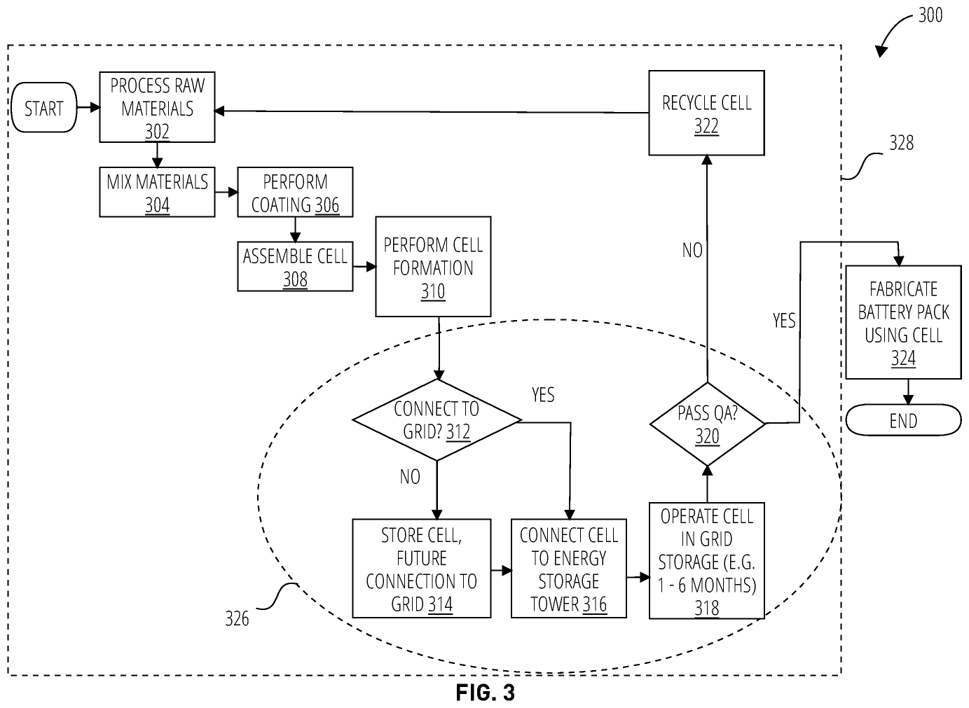

With reference to FIG. 3, a flowchart describing a factory to grid process 300 is shown. The factory to grid process 300 may a manufacturing stage 328 wherein cells are manufactured to be used in fabricating EV battery packs. The cells may be inventoried or binned into performance bins during an inventorying stage 326 based on a grade assigned each cell from measuring a parameter of the cell. The factory to grid process 300 of FIG. 3 begins at step 302, at which the cell batteries are fabricated. For example, raw materials such as lithium carbonate may be processed into a powder to obtain active material for the electrode of a cell. In step 304, the active materials may be mixed and coated (step 306) onto the electrode substrate. Once complete, the cell may be assembled in step 308 responsive to which the cell may be activated in a formation step (step 310) wherein an initial charge/discharge operation may be performed on the battery cell. During this stage, special electrochemical solid electrolyte interphase (SEI) may be formed at the electrode, mainly on an anode. However, an SEI layer may also be deposited in an anode-free cell. The SEI layer may be sensitive to many different factors and may have major impacts on battery performance during its lifetime. Battery formation can take many days depending on the battery chemistry. Using a 0.1 C (C is the cell capacity) current during formation may be typical, taking up to 20 hours for a full charge and discharge cycle, making up 20% to 30% of a total conventional battery cost. Further, the SEI film formation may have a significant impact on the performance of electrode materials. On the one hand, parts of the lithium ions may be consumed during the development of the SEI layer, increasing the irreversible capacity of batteries while decreasing the charge and discharge efficiency of the electrode material. The SEI, on the other hand, may be insoluble in organic solvents and may exist in a stable state in organic electrolyte solutions. Furthermore, solvent molecules may not travel through it, effectively preventing ion co-embedding and preventing electrode material degradation and thereby improving cycling performance and service life of the cell. By using an architecture disclosed herein, feedback may be provided to more precisely control the formation process and enhance the quality, capacity and lifetime of the cell. For example, in an anode-free (“anodeless”) cell, a larger amount of lithium than the amount used in conventional cells having a graphite anode, may be deposited. This may however be influenced by environmental factors and other factors that may cause a deviation from expected film thickness. By using the architecture disclosed herein, a cell parameter or quality metric may be measured during a series of charge-discharge cycles in an inventorying stage 326 to inform on cell quality and to provide feedback on precisely changing formation parameters during formation to deposit the precise amount of lithium ions needed, taking into consideration said environmental factors and improving future cell quality. By performing the charge-discharge cycles during the inventorying stage 326 over a substantially larger period of time than conventionally performed (e.g., 30 days instead of conventional 3 or 4 days) which may hitherto be considered significantly cost prohibitive and thus highly impractical, cell parameters may be more accurately monitored while efficiently recycling energy to inform on cell quality. More generally, other types of batteries and fabrication processes may be used to manufacture cells and battery packs during this manufacturing phase, which are then provided to later stages. Suitable cell parameters and quality metrics may be used depending on the specific cell chemistry and arrangement to achieve the benefits disclosed herein.

The inventorying stage 326 may begin at step 312, wherein a decision may be made on whether to connect the cell to the grid/microgrid/renewable energy source. Upon making a decision to store the cell, the cell may be stored (step 314) for future connection to the grid. Responsive to deciding to connect the cell to the grid, the cell may be disposed (step 316) in an autonomous energy storage tower, discussed herein, and operated in a series of selective charge-discharge cycles for (i) for quality assessment and/or (ii) serving as a reservoir for temporarily storing energy from the grid to be retrieved later (step 318). Upon a determination that the cell has passed quality assessment (performed using at least data obtained from the series of charge-discharge cycles), the manufacturing stage of the cell may be complete, and the cell may be used to fabricate a battery pack for an electric vehicle or for other purposes such as consumer purposes. Upon determining that the cell failed the quality assessment, the cell may be recycled back into raw materials for processing. Thus, a highly energy efficient and scalable large-scale energy storage facility may be obtained.

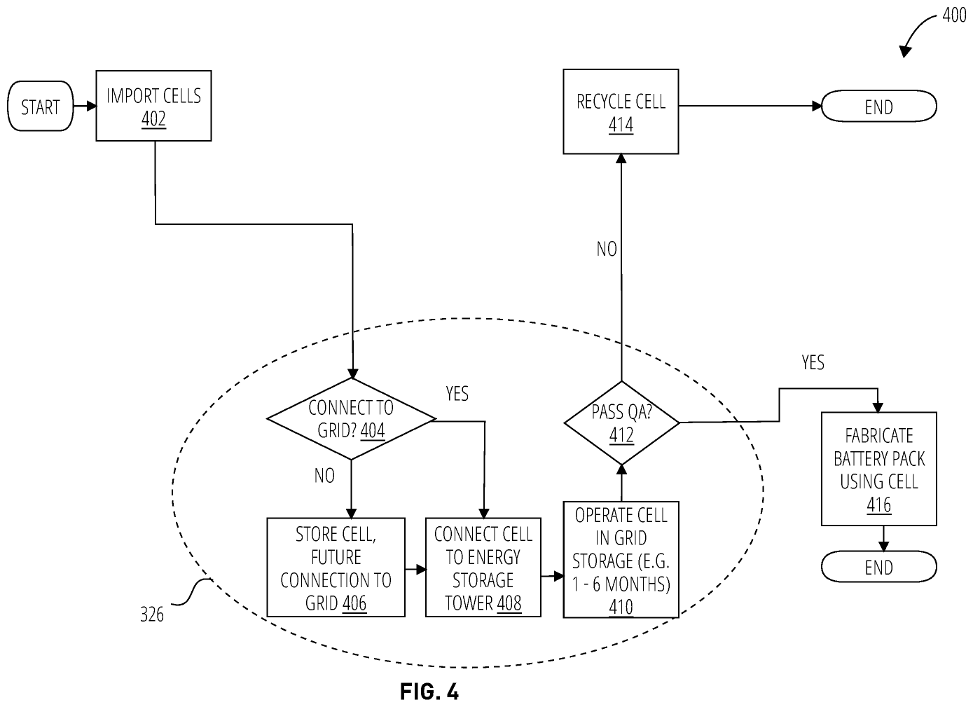

In FIG. 4, another factory to grid process 400 is disclosed. Unlike process 300, process 400 may begin at step 402 wherein a cell that has already undergone a formation process may be imported for inventorying. A decision may be made (step 404) on whether to connect the cell to the grid. The cell may be stored (step 406) upon deciding that a connection is not needed, and the cell may be connected to the grid via the autonomous energy storage tower (in step 408) upon deciding that a connection is needed. Similarly, to process 300, the cell may undergo a series of selective charge-discharge cycles for quality assessment and/or to serve as an energy storage reservoir. Upon passing quality assessment, the cell may be used in a battery pack manufacturing process (step 416) or recycled if the cell fails quality assessment (step 414).

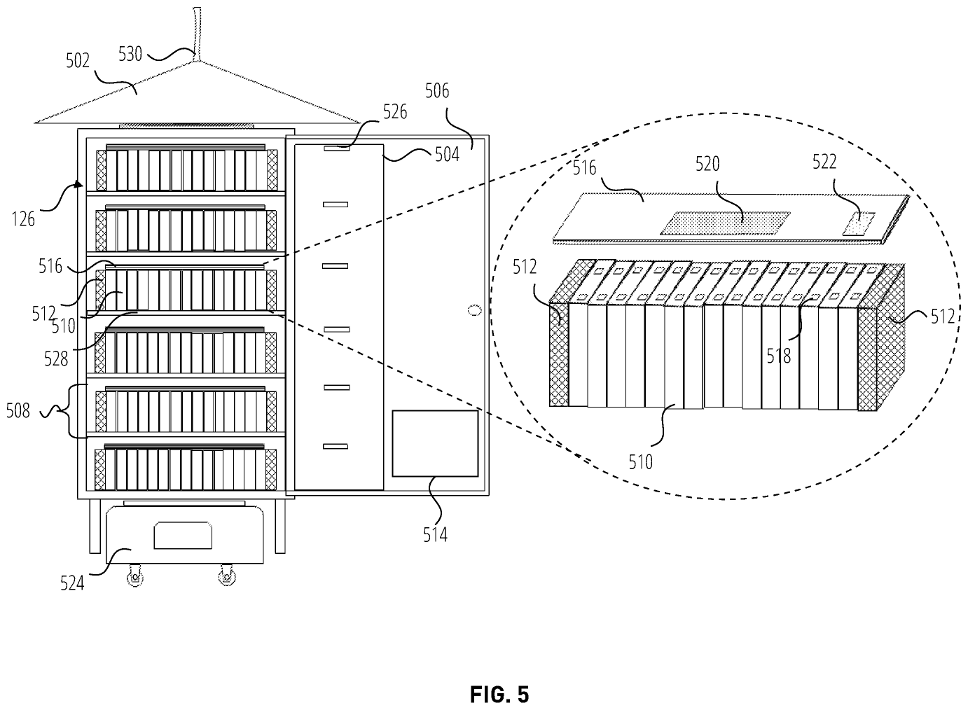

FIG. 5 shows an energy storage tower 126 comprising a grid connection unit 502, an energy storage tower door 506, a plurality of cells 510, a temporary cell array compression unit 512, a temporary cell array electronic circuit 516, cell terminals 518, a battery management system (BMS 520), a first electrical connector 522, a mobile drive unit 524, a second electrical connector 526, a cell array tray 528, power conversion module 504, and energy management system 514, and a magnetic interface lock with an electrical connector from grid 530.

As shown in FIG. 5, the plurality cells may be configured as one or more cell arrays 508 having a temporary no-weld architecture (no permanent physical connections between the cells and external devices, unlike in a battery pack). The temporary no-weld architecture may comprise the temporary cell array electronic circuit 516 configured to connect to positive and negative cell terminals 518 albeit in a non-permanent way. For example, there may not be any welds or permanent connections between the cells and the temporary cell array electronic circuit 516. Further, the cells may be compressed by the temporary cell array compression unit 512 without any welds or permanent connections between the cells 510 and the temporary cell array compression unit 512. Compressing the cells 510 may enable reduction of cell degradation and maintain cell health. Generally, an energy storage tower 124 may comprise any architecture configured to harness excess energy from external sources for use in a quality assurance charge-discharge process of a plurality of cells. A suitable arrangement of cells, electrical connections and switches may be used to construct and energy storage tower 124 depending on energy storage requirements as well as cell capacity requirements.

The energy storage tower 126 may have one or more BMSs 520. In an embodiment, each cell array 508 may have a corresponding BMS 520 whereas in another embodiment, a housing or energy storage tower door 506 may comprise power electronics including one or more BMSs 520 and electric connectors (second electrical connector 526) configured to send or receive information or cell-level measurements from the cells 510 or cell arrays. In some cases, to discharge cells, cells 510 may be connected in series with each cell having a balancing device connected in parallel to discharge individual cells as discussed herein. Of course, this is not meant to be limiting as other implementations may be obtained by persons of ordinary skill in the art in view of the descriptions herein. The BMS may be a core component of the energy storage tower and may performs several critical functions. The primary job of the BMS may be to protect the cells from damage in a wide range of operating conditions. It may ensure that the cells operate within their prescribed operating windows for the state of charge, voltage, current, and temperature. This may be essential to prevent fires or explosions caused by thermal runaway and combustion. The BMS may be configured to constantly monitor critical information of the individual cells and enable charging and discharging of individual cells through balancing circuits. This may include recording vital electrical operating parameters as well as electrolyte levels, internal cell temperature, and ambient temperature. All of this information may be collected and used for maintenance and runtime estimates of the cell array asset.

The grid connection unit 502 may be configured to connect to the cells to the grid via a magnetic interface lock with an electrical connector from grid 530. The magnetic interface lock may enable automatic and fast connection without a need for human presence. However, other non-magnetic implementations to couple the cells to the grid may be realized. A first electrical connector 522 may enable a non-permanent electrical and physical connection between the cells or cell array to other electronic circuits outside of the cell array. The energy storage tower may be made autonomous via a separate or integrated mobile drive unit 524. In an embodiment, the mobile drive unit may be configured to receive movement instructions (for example, information from a machine learning engine) about a position to drive the energy storage tower to and execute movement instructions based on said received instructions. Further, in an embodiment, each cell array 508 may have a cell array tray 528 upon which the cells 510 may be disposed.

The energy storage tower may also have a power conversion module 504 configured to convert energy into the appropriate form to electrically couple the energy storage tower to the grid or an energy source. For example, the power conversion module may be located in the energy storage tower door 506 or housing or grid connection unit of the energy storage tower. Further, the energy storage tower may be directly coupled to a renewable energy source (e.g. solar system) via a DC to DC converter or MPPT (Maximum Power Point Tracking) charge controller system. An MPPT charge controller system may be a DC to DC converter that may optimize the match between a solar array (PV panels), and a battery bank or utility grid. These direct coupling systems may possess higher efficiency that invertors. Moreover, as conventional grid scale invertors, typically rated 100 KW at 480 VAC may yield approximately 208 amps, string inverters (devices used with solar arrays to convert the energy that is generated to usable electricity for a home, and which may force performance to be equal to that of a worst performing solar panel) rated 100 KW at 1000 VAC may be used to yield approximately 100 amps. This reduction in amperage may reduce heat in cabling and may reduce the required diameter of wires resulting in cost savings. Cable connectors may also be smaller for easier wiring and connection. Thus, not only may towers be coupled with 480 VAC invertors with 400 VDC input, they may also be coupled with other systems and architectures such as a 1000 VAC invertor with 1000 VDC input. Further, multiple towers (e.g., up to 50, or 100 towers) may be combined to be electrically coupled to one large central inverter/converter, rated up to, for example, 3000V. Central inverters for utility scale may go up to 4-5 MW, for example. Thus, 40-50× less inverters may be used compared to using 100 KW string inverters.

The power conversion module may be configured to enable power to flow from DC to AC or vice-versa (bi-directional AC-DC converter), which may effectively enable the energy storage tower to both charge and discharge cells. The power conversion module may also have a bi-directional DC-DC converter to allow the energy storage tower to receive energy directly from a renewable energy source such as a DC output of a solar photovoltaic energy source. The power conversion module may direct the flow of energy by commanding the cells' charge and discharge behavior. Thus, the power conversion module may be informed directly or indirectly (through, for example, the BMS) on the available capacity of the cells responsive to which it may stop charging when the cell is full. This may also be driven by metered information at the large-scale energy storage facility or through external signals about when to charge and discharge cells. Thus, the power conversion module may be configured to, (i) responsive to determining or receiving confirmation that a formation process is complete (due to, for example, the cell being connected into the tower), receive electrical energy from the grid or energy source and to selectively supply said electrical energy to one or more of the plurality of cells in a charging mode, and (ii) responsive to determining or receiving confirmation that a formation process is complete (due to, for example, the cell being connected into the tower), selectively retrieve electrical energy from one or more of the plurality of cells to supply said electrical energy to a grid or the energy source in a discharging mode. It may be noted that, in some embodiments, the energy storage tower may also serve as the same infrastructure in which formation (step 310 of FIG. 3) is performed.

The energy storage tower may further comprise an energy management system 514 configured to handle the controls and coordination of energy storage and charge-discharge cycle activity. The energy management system may communicate directly with the power conversion module and the BMS to provide high-level coordination of the various energy storage towers in the large-scale energy storage facility, often by referencing external data points. The energy management system may make decisions on when and how to charge, discharge, remove a cell from the inventorying stage, as well as other operational efficiency decisions. This may be driven by an economic value stream, such as a maximum allowed cell degradation, demand-charge management, time-of-use arbitrage etc. The energy management system 514 may optimize the performance of the energy storage tower by weighing long-term cycling and capacity degradation with the return on investment of the asset. In some embodiments, this may be based on predetermined computational algorithms. However, in other embodiments, the energy management system may utilize or include a machine learning engine to optimize multiple value streams concurrently, as discussed herein.

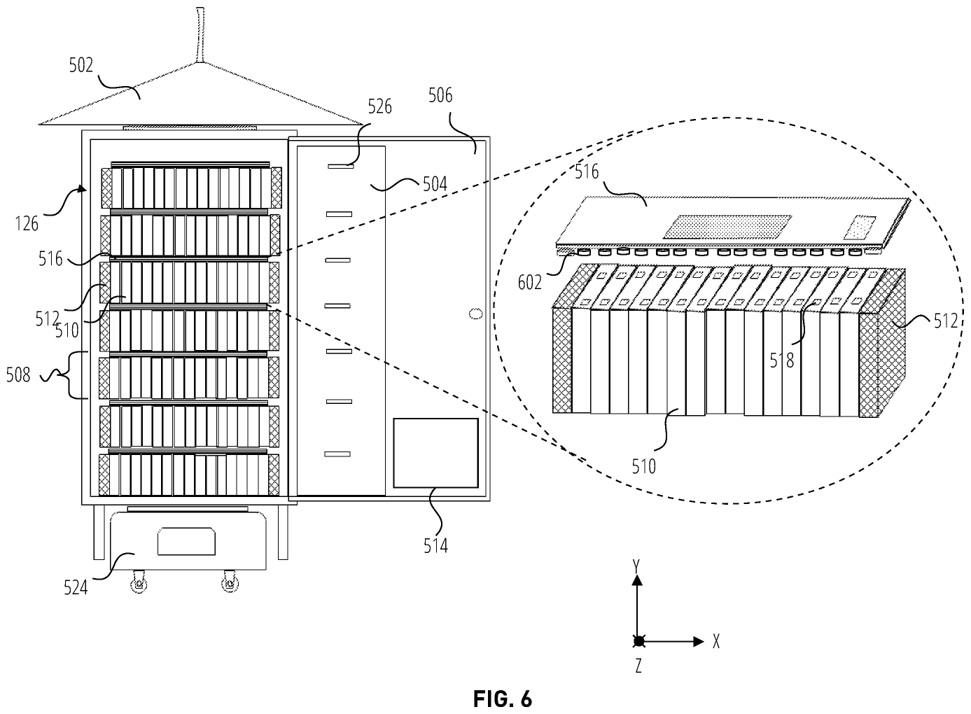

FIG. 6, illustrates another embodiment of the energy storage tower wherein cells may be stacked onto one another in a vertical direction (Y-Direction). Thus, cell array trays 528 may not be necessary. Further, the temporary cell array electronic circuits 516 may have non-permanent cell connection devices such as electrical contact springs 602 or other electrical contact configured to connect cell terminals 518 to the electronic circuit of the temporary cell array electronic circuit 516. By using the electrical contact springs 602, pressure exerted on lower lying cells by upper cells may ensure a consistent and reliable electrical coupling between cells 510 and other electronics of the energy storage tower via the temporary cell array electronic circuit 516. Of course, other implementations of the energy storage tower 126 may be envisioned in light of the descriptions herein.

In one aspect, the one or more cells of the cell array have not completed a manufacturing stage and are awaiting a quality assessment. Further, the energy source may be a renewable energy source such as a solar photovoltaic energy source, a wind energy source, or a biomass energy source. Other intermittent energy sources may also be used, especially when it may be beneficial to store the produced energy at a time when a need for said energy by consumers is minimal. Further, heat produced in some instances in the operation of cells may be obtained for use in a cogeneration or “combined heat and power (CHP)” process to increase efficiency.

In another aspect, each cell array may be configured to provide an energy output of between 10 kWh to 20 kWh, or between 100 kWh and 200 kWh, or between 50 kWh and 500 kWh. The energy storage tower may also be configured to provide a 400V output which may be converted to a 3-phase AC voltage of 480V via a DC-AC converter (DC of cells to AC of grid).

In another aspect, all cells of the plurality of cells may be configured to have a first defined conventional cell chemistry (such as a lithium-ion phosphate (LFP) chemistry). Alternatively, all cells of the plurality of cells may be configured to have a second defined chemistry different from the first chemistry. As another option, the energy storage tower may have two or more distinct cell chemistries in the same tower.

In yet another aspect, a large-scale energy storage facility 124 is disclosed that may comprise at least one energy storage tower (the at least one energy storage tower may comprise a mobile drive unit and may thus be an autonomous energy storage tower). For example, the large-scale energy storage facility 124 may also comprise between 10,000-20,000 autonomous energy storage towers, or between 5,000-50,000 autonomous energy storage towers. Moreover, the large-scale energy storage facility may be configured to have a capacity to store between 1-20 GWh of energy, or between 5-15 GWh of energy storage.

The large-scale energy storage facility may be operated by tower-by-tower cycling of cells of the autonomous energy storage towers to provide energy to the grid. It may also be configured to inventory of only cells having a high cycle life, low energy density chemistry or only cells having a low cycle life, high energy density chemistry or both.

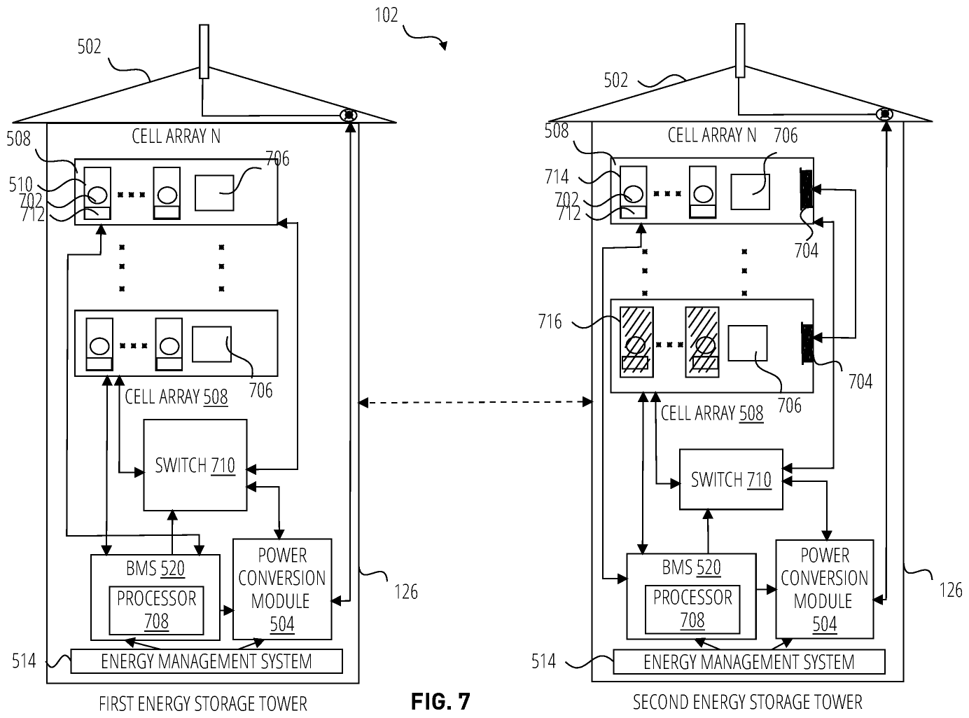

FIG. 7 is an embodiment illustrating a system diagram of an energy storage tower 126. The embodiment recognizes that it may be advantageous to be able to independently measure parameters of individual cells in a cell array 508. This may enable charging or discharging each cell individually, as opposed to charging or discharging all cells in the cell array at the same time. One way of achieving this may be to connect the cells in a series arrangement. The illustrative embodiments recognize that most conventional cells are connected in parallel, precluding an ability to control input and output currents passing through the cells. The illustrative embodiments also recognize that when individual cells fail, it may be difficult to maintain an integrity and performance, as the death of the cell is accelerated due to a failure to detect and/or mitigate said failure in time. Moreover, in some configurations, an entire array of cells may be rendered unusable when one cell fails.

As shown in FIG. 7, energy storage tower 126 may be configured to include low performing, high energy density chemistries (e.g., cell with first chemistry 714). The energy storage tower may also have a low energy density, high cycle life chemistries (e.g., cell with second chemistry 716 different from the first chemistry). In one embodiment, one cell array or tower has an LFP chemistry, and another cell array or tower has an anode free chemistry. Thus, the energy storage tower 126 may be designed to have one or a plurality of cell arrays 508 that are configured with respective bi-directional DC-DC converters 704 to act as standalone cell arrays. By being able to independently control the cell arrays 508, and independently measure the health or state of its individual cells 510, a charging and discharge rate the cells 510 can be regulated.

The energy storage tower comprises one or more processors 708 included in or outside an on-board or external computer system such the BMS 520, power conversion module 504 or energy management system 514 to monitor and manage the electrical power discharging and charging processes of cells. Each cell array 508 may also comprise one or more sensors 702 configured to measure parameters of each cell, a bi-directional DC-DC converter 704 configured to enable transfer of energy between cell arrays, a cell array controller 706 that may handle cell-level operations and, a balance device 712 that may be connected in parallel with each cell to enable discharging the cell if needed. By using a balance device 712 connected in parallel with each cell, a some discharging steps of the cell can be controlled, i.e., Turning on the balancing device, discharges the electric charge stored in the cell. Further, one or more sensors 702 (such as a voltage sensor) are used to measure a state of the individual cells and/or the cell array 508. The rate at which a battery is discharged relative to its maximum capacity is its C-rate. For example, a 1 C rate means that the discharge current will discharge the entire battery in 1 hour. Typically, a vehicle needs 4 C peak, and 1 C average. By controlling the cells in cell arrays 508 individually with bi-directional DC-DC converters 704, a rate of C/5, for example, or less can be achieved. This may prevent triggering failure events associated with high energy density chemistries due to excessive charging and discharging.

The energy storage tower may also comprise one or more switches 710 that may be configured to connect or disconnected a conducting path. Further, as used herein, a sensor may be a device that can be a system, an apparatus, software, hardware, a set of executable instructions, an interface, a software application, a transducer and/or various combinations of the aforementioned that include one or more sensors/detectors utilized to indicate, respond to, detect and/or measure a physical property and generate data concerning the physical property.

In an aspect, a first energy storage tower may provide energy to a second energy storage tower as shown in FIG. 7 to facilitate the quality assessment of the cell during the series of charge-discharge cycles. This may be due to, for example, an indication that the grid no longer needs energy for a period of time. Thus, the grid connection unit 502 or another connection may be configured to couple the first energy storage tower with the second energy storage tower. Due to an availability of a bi-directional DC-DC converter between the two towers, energy may be transferred bi-directionally, and the quality assessment may thus proceed uninterrupted.

Further, with respect to the BMS, may be configured to monitor the state of the cells 510 to prevent overcharging and discharging that may reduce the battery's life span, and capacity. For instance, the BMS may monitor the power voltage, and when the required voltage is reached, it stops the charging process. In case irregular patterns in the power flow are detected, BMSs shut down and send out an alarm. Moreover, the BMSs can be configured to relay the information about the cell condition to the energy and power management systems.

In an embodiment, each cell array 508 also has one or more controllers or an operatively coupled cell array controller 706 configured to measure the health or state of the cells. For example, a cell array controller 706 can be configured to measure the voltage, current, temperature, SOC (State of Charge), SOH (State of Health) for each cell of the corresponding cell array 508. It may also have a DC-DC converter control to allow isolation and current to be managed and throttle their contribution, both absorbing and providing energy to a grid. In case a cell array, malfunctions, one of more of other cell arrays may act as a replacement, (e.g., temporary replacement) for the energy storage tower 126 by supplying power directly to the grid connection unit 502. Of course, other ways of measuring the parameters of each cell independently, such as by providing each cell with a controller or measurement device or sensor may be obtained by in view of the descriptions herein.

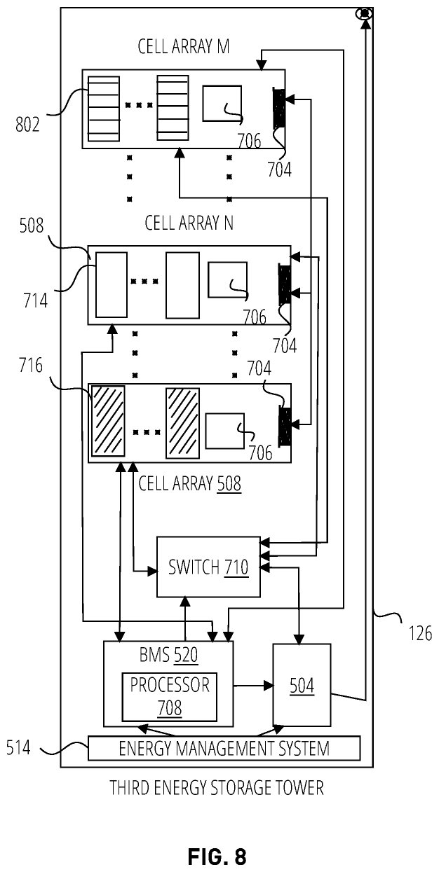

FIG. 8 depicts another embodiment of the energy storage tower 126 comprising more than two chemistries. Herein, cells with a third chemistry 802 (e.g., Gr+SS (Graphite+Solid State) chemistry) may be provided in a third cell array and cell operations may be dependent on the corresponding chemistry.

Grading and Sorting Cells

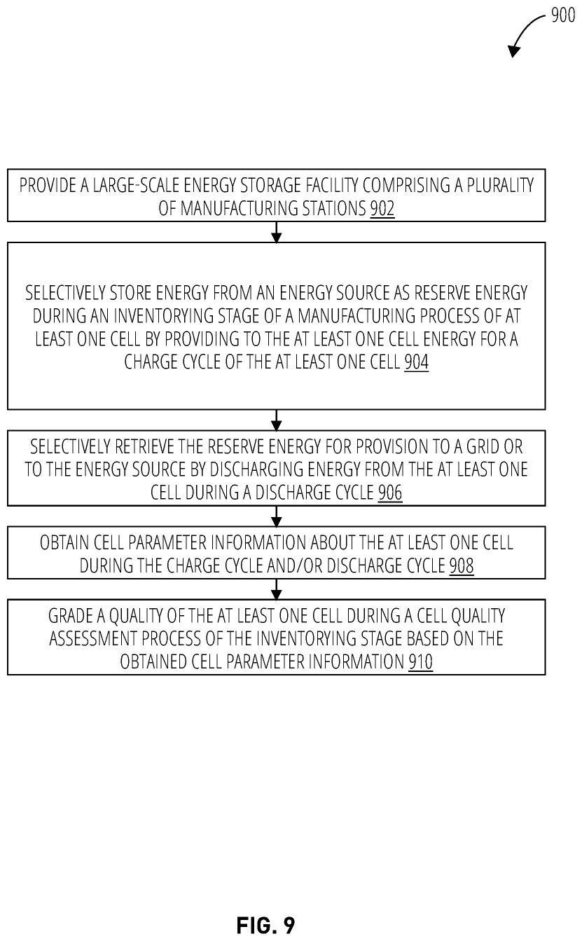

FIG. 9 illustrates a process 900 of grading and sorting the cells 510 based on measured cell parameter information. By running cycles of charging, resting and discharging, over a period of time, a plurality of cell parameters such as capacity, open-circuit voltage, cut-off electricity consumption, internal resistance etc., may be measured for each cell and used in grading said cells. Furthermore, precise voltages and current may be needed for charging and discharging the cells. The process may begin at step 902 wherein a large-scale energy storage facility comprising a plurality of manufacturing stations may be provided. In step 904, process 900 may selectively store energy from an energy source or grid as reserve energy by providing to at least one cell of a plurality of cells disposed in one or more energy storage towers of the facility the energy from the energy source, the selectively storing step being performed during an inventorying stage of the cell manufacturing process. This energy storage also serves as a charge cycle during which parameters of the cell may be measured (step 908). In step 906, process 900 may selectively retrieve the reserve energy for provision to a grid or to the energy source by discharging energy from the at least one cell during a discharge cycle. Parameters of the cell may also be measured during the discharge (step 908). After completion of the charge-discharge cycles, which may for example be determined by a pre-defined number of cycles, the quality of the cell may be assessed, and the cell may be graded. In step 910, process 900 grades the quality of the at least one cell during the cell quality assessment process of the inventorying stage 326 based on the obtained cell parameter information. Based on the grades, the cells may be sorted into performance bins wherein cells of the same or substantially the same parameters may be grouped categorized together. Further, based on the grades, feedback may be provided for optimizing the formation process. For example, a time period of a formation process of the manufacturing stage 328 may be reduced compared to conventional formation times based on information retrieved about a quality of the cells during the quality assessment process. Even further, the steps of the selectively storing or selectively retrieving energy may be based on information selected from the list consisting of information about a transmission, a congestion, a frequency modulation of the grid, a flow of power to the grid, an environmental weather condition, an energy input into the large-scale energy storage facility, a required cell lifetime, a required cell-end-of-manufacturing capacity, a maximum cell-end-of-manufacturing degradation, and a cell chemistry and the like. In an aspect herein, when the energy source is a renewable energy source, the energy may be stored at peak production times of the renewable energy source to prevent loss of said energy, and where the stored energy may be selectively provided back to the renewable energy source at low production times of the renewable energy source.

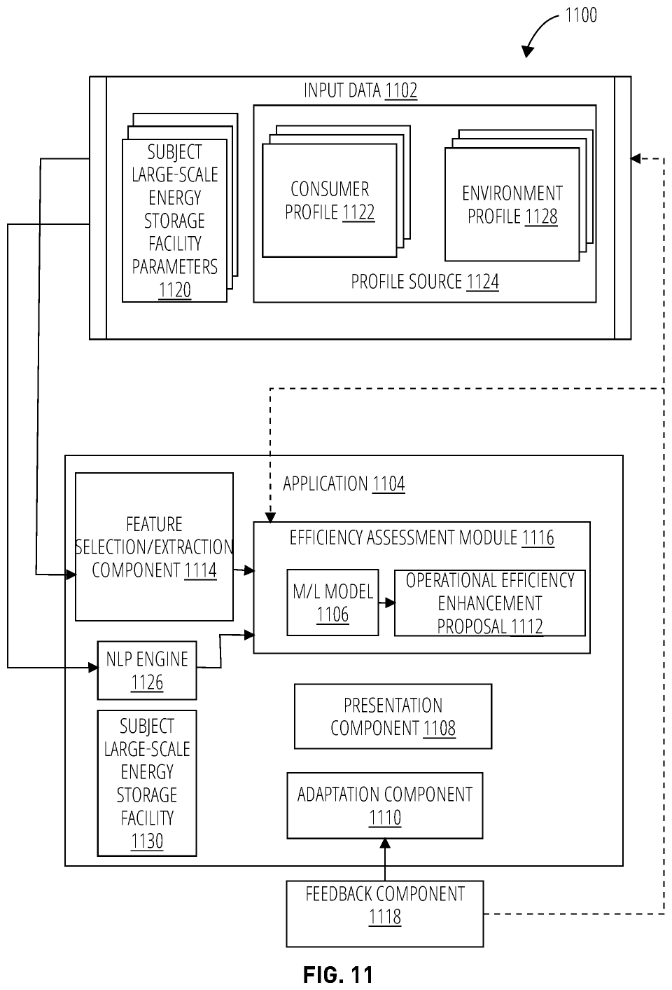

Some or all of the process 900 may be implemented by a machine learning system as disclosed herein. For example, a machine learning process may be used to perform step 910 using the cell parameter information as inputs to the battery grading determination. In such an implementation, the cell parameters measured at step 908 or otherwise available for each cell may be used by the machine learning system to determine a grade for a battery, where the machine learning system was previously trained on batteries of various known grades in conjunction with the same cell parameters for each battery used during the training process. As another example, a process equivalent to the process shown in FIG. 11 may be performed using features related to cell performance disclosed herein, to derive a battery grade.

Of course, the examples described are not intended to be limiting as other variations may be envisioned by persons of ordinary skill in light of the descriptions presented.

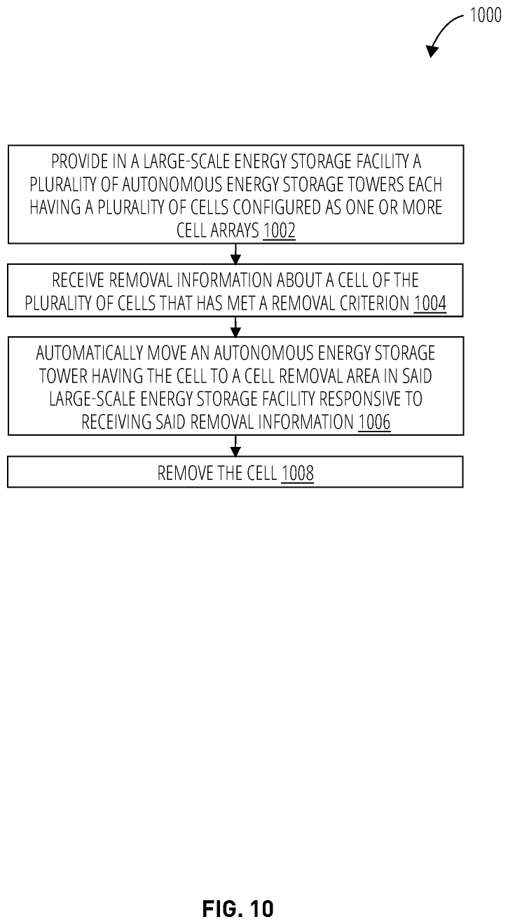

FIG. 10 discloses another process 1000 for moving an autonomous energy storage tower and providing an indication that a cell has completed a manufacturing stage. In step 1002, a large-scale energy storage facility is provided. The large-scale energy storage facility comprises a plurality of autonomous energy storage towers each having a plurality of cells disposed on a plurality of vertically stacked trays. In step 1004, process 1000 receives removal information about a cell of the plurality of cells that has met a removal criterion. The removal criterion may include, for example, an assessment of an age of the cell (e.g., 30 days of charge-discharge cycles after connection to the grid), a maximum number of charge and/or discharge cycles or a required grade of the cells. The removal criterion may also be obtained from a machine learning engine. In step 1006, process 1000 cause automatically move the autonomous energy storage tower having the cell to a cell removal area in the large-scale energy storage facility responsive to receiving the removal information. In an example, a first in-first out model may be adopted wherein the removal may be dependent on the time said cell has spent in the inventorying stage. Thus, energy may be selectively stored in one or more new cells via corresponding charging cycles of the one or more new cells and said energy may be selectively retrieved from the one or more existing cells via corresponding discharge cycles of the one or more existing cells. Thus, the first cell to be connected to the grid may more likely be removed first to conclude the manufacturing of said first cell. In step 1008, process 1000 removes the cell.

Intelligent Operational Efficiency Enhancement-Machine Learning Engine

The illustrative embodiments further recognize that conventional storage systems for the grid may be mostly reactive, incapable of predicting energy consumption needs and restricted to storing energy in a way that is heavily dependent on an available capacity. The illustrative embodiments recognize that while storage needs may be estimated to prepare for incoming energy, this may be largely error prone and may not account for external influencing factors such as environmental conditions. Further, little to no mitigation measures may be available to ensure cell safety or preserve available life and capacities. Moreover, cells used may be already manufactured cells and thus there may not be any requirement to ensure a that a threshold amount of cell degradation is not exceeded. The illustrative embodiments further recognize that the load following nature of conventional grid systems, which may have limited control over changing consumption requirements, means that the current input and output for cells may not be precisely controlled.

As far as managing the chemistries of individual modules of an energy storage system, presently, conventional modules may charge and discharge all individual modules together. The illustrative embodiments recognize that monitoring the chemistries of individual cells in a larger system and controlling them individually to ensure the efficiency and safety of the system as a whole may be critical. For example, by being unable to disable individual cells and cell arrays without the need to disable the larger system beneficial as the safety of the system may be enhanced and the available life cycles of individual cells may be prevented from being unduly shortened from overcharging and over discharging.

The illustrative embodiments thus recognize that presently available tools or solutions do not address the need to provide intelligent management of cells in a large-scale energy storage facility where cell manufacturing is combined with energy storage.

The illustrative embodiments used to describe the disclosure generally address and solve the above-described problems and other related problems by intelligent proposal of large-scale energy storage facility operations that may enhance energy delivery, cost, and battery efficiency of the facility as a whole. The illustrative embodiments may solve these problems in a preparatory or “forward-thinking” process that anticipates the power demands of grids, microgrids, renewable energy sources and/or other energy sources and operates to meet said demands while exploiting the storage and retrieval operations to perform quality assessment of cells in a series of corresponding charge-discharge cycles.

Concerning intelligent proposals, certain operations are described as occurring at a certain component or location in an embodiment. Such locality of operations is not intended to be limiting on the illustrative embodiments. Any operation described herein as occurring at or performed by a particular component, e.g., a predictive analysis of cell data and/or a natural language processing (NLP) analysis of contextual calendar or weather data, can be implemented in such a manner that one component-specific function causes an operation to occur or be performed at another component, e.g., at a local or remote machine learning (ML) or NLP engine respectively.

An embodiment monitors and manages cumulative energy of the large-scale energy storage facility. Another embodiment may monitor a variety of profile sources configured for consumers of the facility, for example, a renewable energy storage plant that may need to store energy during high production times, or an EV manufacturing plant that may need to acquire a plurality of manufactured cells that meet a defined grade, or a facility owner with a target overall cost efficiency. A profile source may be an electronic data source from which information usable to determine a profile characteristic of the consumer can be obtained. For example, a profile source may be consumer preference configuration on a computing device such as a required time of storage, capacity available for storage, a calendar application where the consumer's energy generation events are planned, feedback from the consumer or group of consumers and the like. A profile source can be a device, apparatus, software or a platform that may provide information from which an energy storage or delivery characteristic of the consumer may be derived. For example, a dashboard 114 may operate as a profile source within the scope of the illustrative embodiments. Moreover, a community such as a group of renewable energy sources 130 or other energy sources can be a profile source wherein a plurality of storage and delivery characteristics may be obtained to derive a preference, liking, sentiment, or usage of energy. Further, measured health metrics or parameters about individual cells or cell arrays of energy storage towers 126 may be input data and may be utilized to learn from and derive patterns for storing and retrieving energy in the large-scale energy storage facility.

A consumer's profile data, information and preference, are terms that are used herein interchangeably to indicate a constraint of one or more users that may affect energy storage and delivery. Data from an environment such as weather data, environmental impact assessment, or otherwise other environmental data may form part of an environment profile 1128.

Furthermore information/data about the large-scale energy storage facility 124 and cells 510 (such as cell manufacturing duration, number of activated energy storage towers, cell current, temperature, voltage, impedance, state of health (SOH), state of charge (SOC), average energy consumption, and the like or otherwise subject large-scale energy storage facility parameters 1120 may form part of or be separate from the constraints and may be obtained for use as input to an intelligent efficiency assessment module 1116 for predictive analytics as described hereinafter. Thus, the profile source 1124 information and subject large-scale energy storage facility parameters 1120 may collectively form at least a part of the input data 1102 or constraints for the intelligent efficiency assessment module 1116 to predict cell and manufacturing operations to maximize storage capacity while minimizing cell degradation.

The input data 1102 as determined by an embodiment may be variable over time. For example, cells may have time varying parameters that may be measured and used as input. This may provide real time proposals for efficiently operating the large-scale energy storage facility 124. Similarly, the grid or energy source may indicate a need for a pause in energy exchange. However, cell manufacturing may still be needed. This the efficiency assessment module 1116 may propose an option to exchange energy between two sets of energy storage towers or between two sets of cell arrays 508, through bi-directional DC-DC converters connected therebetween.

Further, based on predictive analytics about a power or energy consumption during certain seasons of the year, the efficiency assessment module 1116 may propose increasing or decreasing a manufacturing capacity, a number of cells disposed in energy storage towers in the large-scale energy storage facility, or relative proportion of cells to be maintained at various phases of the systems and techniques disclosed herein, to meet the predicted demand increase or decrease.

Ultimately, the efficiency assessment module 1116 may control input and output power of the cells while concurrently ensuring that the safety, maximum life cycle and maximum capacity attributes of the individual cells are considered. For example, upon determining that high energy density cell A has a fault based on sensor information obtained about the independently measurable cell, the efficiency assessment module 1116 may deactivate cell A or the corresponding cell array of cell A and utilize high energy density cell B or the corresponding cell array of cell B to for energy delivery purposes, thus ensuring the safety of the energy storage tower pack and allowing the eventual restoration of deactivated cell A or cell array of A through a formation recharge. In another example, upon determining that high cycle life cell C has 3000 cycles remaining, the efficiency assessment module 1116 may prioritize cycling cell C for energy storage before utilizing cycles from a lower cycle cell. User feedback indicative of an accuracy of proposals in enhancing cost efficiency, cell lifetime and minimizing degradation may be used to modify the efficiency assessment module 1116 to produce better results.

Operating with profile information from one or more profile sources, an embodiment routinely evaluates the constraints that are applicable to the cells and consumer of the large-scale energy storage facility. The embodiment adds new constraints/input data when found in profile information analysis, modifies existing constraints when justified by the profile information analysis, and diminishes the use of past constraints depending on the feedback, the observed usage of the constraint and/or presence of support for the past constraint in the profile information. A past constraint may be diminished or aged by deprioritizing the constraint by some degree, including removal/deletion/or rendering ineffective the past constraint. More generally, profile information may be obtained from any source available to the large-scale energy storage facility.

The intelligent operational efficiency enhancement proposals and techniques described herein generally are unavailable in the conventional methods in the technological field of endeavor pertaining to cell manufacturing and energy storage systems. A method of an embodiment described herein, when implemented to execute on a device or data processing system, comprises substantial advancement of the functionality of that device or data processing system in proposals by obtaining constraints and using an advanced tower architecture that enables control of input and output currents while ensuring maximization of the safety, life and capacity attributes.

In further embodiments, a machine learning engine may be provided to increase the resolution and efficacy of predictions made by a controller based on a comparison of sensed and received information. The machine learning engine may detect patterns and weigh the probable outcomes and energy demand profiles based on these patterns. As a consumer engages with the cells of the large-scale energy storage facility, data regarding the consumption may be collected and stored for analysis by the controller or another network-connected computerized device. The data may be aggregated to allow additional resolution in detecting patterns and predicting behavior. The machine learning engine may perform an analysis on time series data gathered at the cells 510 or environment, supplemental information such as that provided over a network, and/or other information to draw correlations. For example, the machine learning engine may perform a linear algebra regression analysis on the time series step data to find the best-fit parameter values. The machine learning engine may additionally return operational parameters, for example, that may be used by a controller in energy management.

Client application 120 of FIG. 1, dashboard application of FIG. 1, server application 116 of FIG. 1 or any other application such application 1104 implements an embodiment described herein. Any of the applications can use data from the large-scale energy storage facility 124, cells 510 and profile sources to propose operational efficiency enhancements. The applications can also obtain data from storage unit 110 for predictive analytics. The applications can also execute in any data processing systems (server 106 or server 108, client 112, dashboard 114).

Concerning FIG. 11, this figure depicts a diagram of an example configuration for intelligent operational efficiency enhancements in accordance with an illustrative embodiment. The intelligent operational efficiency enhancements can be implemented using application 1104 in FIG. 11. Application 1104 may be an example of server application 116, client application 120 or dashboard application 122, for example. The application 1104 receives or monitors, for example in real time, a set of input data 1102. The input data comprises subject large-scale energy storage facility parameters 1120 such as measured cell parameters, including, for example, temperature of individual cells and that of their neighbors, voltages of the cells, impedances of the cells, state of health of the cells, capacity of the cells, computed polarization curves or charge discharge curves of the cells identifying graphitization plateaus, a required cell lifetime, a required cell-end-of-manufacturing capacity, a maximum cell-end-of-manufacturing degradation, an age of the cell, and a cell chemistry. The subject large-scale energy storage facility parameters 1120 may also include facility parameters such as number of energy storage towers, speed of manufacturing, electricity consumption demand, a time period for providing proposals, an energy input into the large-scale energy storage facility, etc.

The input data may also comprise consumer and environmental characteristics from profile sources 1124 (consumer profile 1122, environment profile 1128) such as preferences, pre-planned energy storage, average daily driving distance, past driving energy consumption per mile, duration of stops, calendar data for a timelining procedure, and environment data such as terrain data, road slope angle, air drag coefficient, road rolling resistance coefficient and the like.

In one or more embodiments described herein, characteristics, properties, and/or preferences associated with a consumer, an environment, a cell, a facility etc. are referred to as “features”. In one or more embodiments, the configuration 1100 defines and configures an algorithm and/or rule to drive feature selection results. In particular embodiments an algorithm may include, for example, determining a lowest common value for a feature, and determining whether the value satisfies a best match within a threshold value (e.g., 90%) of the feature. In an embodiment, the system may prioritize certain features so that features such as cell degradation at an end-of-manufacturing time, cell capacity at the end-of-manufacturing time, cost efficiency of operating cells of the large-scale energy storage facility, amount of capacity available to store energy and a revenue from arbitrage and sale of manufactured cells carry different weights. In an embodiment, after a common denominator in a plurality of consumers is found, the configuration 1100 understands the problems with individual consumers, and extracts and derives the best feature values that will help in intelligent operational efficiency enhancements proposals.

In an embodiment, features may be selected or extracted from outside the machine learning model. However, in another embodiment, features may additionally be extracted inside the machine learning model/deep neural network and thus may be integral to the model. Feature extraction/selection is therefore generally used interchangeably herein.

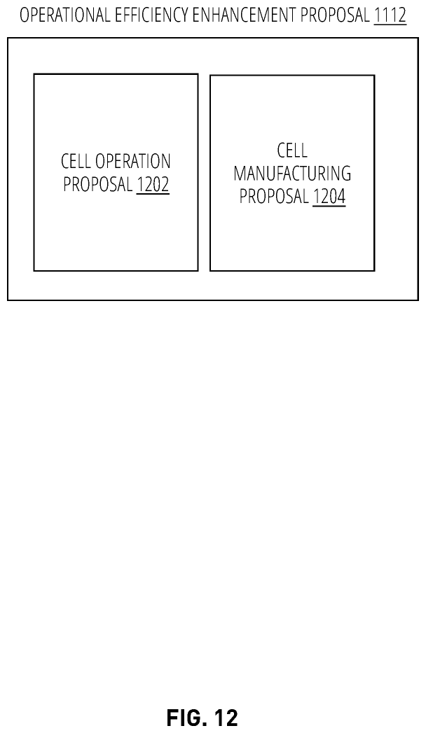

In an embodiment, feature selection/extraction component 1114 is configured to generate relevant features, based on contents of a request from application 1104, using data from all the different available features (e.g., subject large-scale energy storage facility parameters 1120, consumer profile 1122, environment profile 1128). In the embodiment, feature selection/extraction component 1114 may receive a request from application 1104 which includes at least an identification of a subject large-scale energy storage facility parameters as well as instructions to propose a cell and manufacturing operations in to enhance efficiency. Using the subject large-scale energy storage facility parameters and/or profile source 1124, feature selection/extraction component 1114 may obtain a combination of specific subject large-scale energy storage facility parameters 1120, profile information from consumer profile 1122, and environmental data from environment profile 1128. In the embodiment, feature selection/extraction component 1114 may use a defined algorithm of prioritization to generate the features as feature profile. In a particular embodiment, the feature profile includes each feature (e.g., 1. cell current, 2. cell temperature, 3. cell voltage, 4. cell impedance, 5. weather forecast, 8. consumption requirements, 9. state of health audit report indicative of a safety, capacity and remaining life cycles of the cells and 10. weights given to each feature). Using the extracted features and a trained M/L model 1106 that has been trained using a large number of different datasets, efficiency assessment module 1116 may determine an operational efficiency enhancement proposal 1112 for the subject large-scale energy storage facility 1130. The operational efficiency enhancement proposal 1112 may comprise a cell operation proposal 1202 (FIG. 12) and/or a cell manufacturing proposal 1204 (FIG. 12). These may contain information indicative of a predicted state of one or more components of the large-scale energy storage facility and instructions to mitigate the predictions.

In an embodiment herein, the operational efficiency enhancement proposal is a cell operation proposal, and the cell operation proposal comprises information about when and how to charge and discharge the cell. The instructions may further be dependent on cell chemistry. Another cell operation proposal may comprise an indication of a number of cells needed in the large-scale energy storage facility and when to charge and/or discharge them. Said instructions may be at a cell-level or may be at a cell array-level or may be at an autonomous energy storage tower-level. Yet another cell operation proposal may comprise instructions for controlling a rate of charging and/or discharging of the at least one cell. A maximum number of charge-discharge cycles may also be proposed to preserve cell capacity and minimize cell degradation. This may ensure the cells may still meet requirements for use in a battery pack after cell manufacturing is completed. In another embodiment, a cell operation proposal comprises an inventorying/storage time period for at least one cell. This time period may be a factor of a performance of the cell. The cell operation proposal may also comprise instructions for determining a movement parameter of the energy storage tower. This may be used to drive a corresponding mobile drive unit of an autonomous energy storage tower in the subject large-scale energy storage facility. The cell operation proposal may also comprise instructions for grading the cell into a specified performance bin. The cell operation proposal may further comprise instructions for performing a series of energy storage and retrieval operations at defined times to maximize grid-scale arbitrage profits.

In an embodiment, the operational efficiency enhancement proposal may be a cell manufacturing proposal and comprise information about an optimum cell formation parameter for a cell formation procedure in the subject large-scale energy storage facility. This may thus serve as feedback information about an SEI layer thickness and how said thickness may be more precisely controlled to manufacture higher or different grade of cells in the future. The cell manufacturing proposal may also be is dependent on a chemistry the cell.

The proposals may be provided in real time as the input changes. User feedback concerning an accuracy of the proposals may also be used in modifying the machine learning model. By providing one or more of these cell operation and manufacturing operation proposals, and executing said proposals, a highly energy efficient, self-supporting and cost-efficient large-scale energy storage facility may be obtained. These examples are not meant to be limiting and any combination of these and other example power output proposals are possible in light of the descriptions.

The efficiency assessment module 1116 can be based, for example, on a neural network such as a recurrent neural network (RNN), although it is not meant to be limiting. An RNN is a type of artificial neural network designed to recognize patterns in sequences of data, such as numerical times series prediction and numerical time series anomaly detection using data emanating from sensors, generating image descriptions and content summarization. RNNs may use recurrent connections (going in the opposite direction that the “normal” signal flow) which form cycles in the network's topology. Computations derived from earlier input are fed back into the network, which gives an RNN a “short-term memory”. Feedback networks, such as RNNs, are dynamic; their ‘state’ is changing continuously until they reach an equilibrium point. For this reason, RNNs are particularly suited for detecting relationships across time in a given set of data. Recurrent networks take as their input not just the current input example they see, but also what they have perceived previously in time. The decision a recurrent net reached at time step t−1 may affect the decision it will reach one moment later at time step t. Thus, recurrent networks have two sources of input, the present and the recent past, which combine to determine how they respond to new data. Alternatively or in addition, other machine learning systems and techniques may be used, including both supervised and unsupervised techniques. Different algorithms or combinations of algorithms may be selected, for example, based on the specific cell chemistry, physical arrangement, or desired properties of the cells being evaluated and used in the systems disclosed herein. Moreover, predetermined logic may be used, for example, in cases where analyses of a large amount of data is not needed.

In an illustrative embodiment, the operational efficiency enhancement proposals 1112 may be presented, by a presentation component 1108 of application 1104. An adaptation component 1110 may be configured to receive input from a user to adapt the operational efficiency enhancement proposals 1112 if necessary. For example, changing a tolerated cell degradation proposed by the efficiency assessment module 1116 causes a recalculation of operational efficiency enhancement proposal 1112 that takes the new tolerated degradation into consideration.

Feedback component 1118 optionally collects user or consumer feedback relative to the operational efficiency enhancement proposals 1112. In one embodiment, application 1104 is configured not only to compute operational efficiency enhancement proposals 1112 but also to provide a method for a user to input feedback, where the feedback is indicative of an accuracy of the computed operational efficiency enhancement proposals 1112. Feedback component 1118 applies the feedback in a machine learning technique such as to profiles or to M/L model 1106 in order to modify the M/L model 1106 for better proposals. In an illustrative embodiment, the application analyzes said feedback input and the application reinforces the M/L model 1106 of the efficiency assessment module 1116. If the feedback is satisfactory or unsatisfactory as to the accuracy of the proposal, the application strengthens or weakens parameters of the M/L model 1106 respectively.

The input layer of the neural network model can be, for example, a vector representative of a current, voltage or impedance values of cells, contextual weather or calendar data provided by an NLP engine 1126, etc. In an example, a CNN (convolutional neural network) uses convolution to extract features from an input. In an embodiment, upon receiving a request to provide a proposal, the application creates an array of values that are input to the input neurons of the M/L model 1106 to produce an array that contains the operational efficiency enhancement proposals 1112.

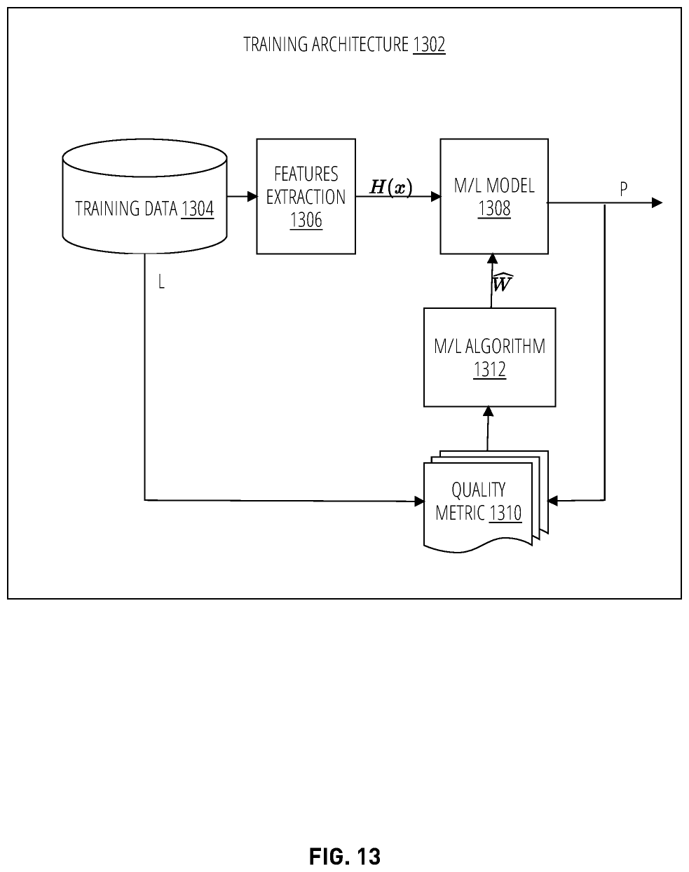

The neural network M/L model 1106 may be trained using various types of training data sets including stored profiles and a large number of sample cell measurements. As shown in FIG. 13, which depicts a block diagram of an example training architecture 1302 for machine-learning based recommendation generation in accordance with an illustrative embodiment, program code extracts various features 1306 from training data 1304. The components of the training data 1304 have labels L. The features are utilized to develop a predictor function, H(x) or a hypothesis, which the program code utilizes as an M/L model 1308. In identifying various features in the training data 1304, the program code may utilize various techniques including, but not limited to, mutual information, which is an example of a method that can be utilized to identify features in an embodiment. Other embodiments may utilize varying techniques to select features, including but not limited to, principal component analysis, diffusion mapping, a Random Forest, and/or recursive feature elimination (a brute force approach to selecting features), to select the features. “P” is the output that can be obtained, which when received, could further trigger the large-scale energy storage facility 124 to perform other steps such steps of a stored instruction. The program code may utilize a machine learning m/l algorithm 1312 to train M/L model 1308, including providing weights for the outputs, so that the program code can prioritize various changes based on the predictor functions that comprise the M/L model 1308. The output can be evaluated by a quality metric 1310.

By selecting a diverse set of training data 1304, the program code trains M/L model 1308 to identify and weight various features. To utilize the M/L model 1308, the program code obtains (or derives) input data or features to generate an array of values to input into input neurons of a neural network. Responsive to these inputs, the output neurons of the neural network produce an array that includes the operational efficiency enhancement proposal to be presented or used contemporaneously.

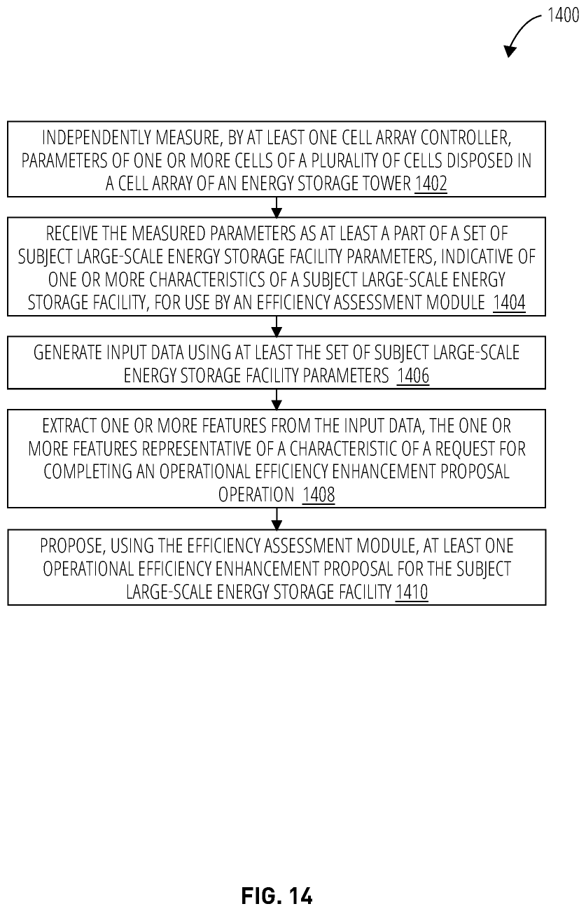

FIG. 14 is a flowchart depicting a summary of the machine learning process 1400 described herein. In step 1402, process 1400 independently measures, by at least one cell array controller, parameters of one or more cells of a plurality of cells disposed in a cell array of an energy storage tower. In step 1404, process 1400 receives the measured parameters as at least a part of a set of subject large-scale energy storage facility parameters, indicative of one or more characteristics of a subject large-scale energy storage facility, for use by an efficiency assessment module. In step 1406, process 1400 generates input data using at least the set of subject large-scale energy storage facility parameters. In step 1408, process 1400 extracts one or more features from the input data, the one or more features representative of a characteristic of a request for completing an operational efficiency enhancement proposal operation. In step 1410, process 1400 proposes, using the efficiency assessment module, at least one operational efficiency enhancement proposal for the subject large-scale energy storage facility. The efficiency assessment module operates as a machine learns engine.

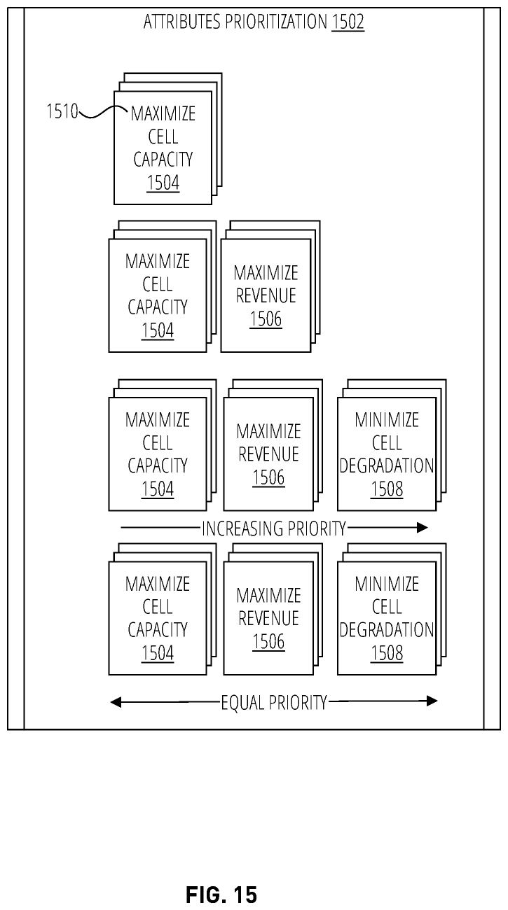

Concerning step 1408, the one or more features may also represent attributes obtained from an attributes prioritization 1502 step, as shown in FIG. 15. In the attributes prioritization, one or more attributes 1510 to consider for an output proposal operation are obtained. The one or more attributes may have different assigned priorities or weights or may have the same or even unassigned priority or weight. By training the M/L model 1306 with a large set of different datasets that consider the attributes 1510, different scenarios can be handled by the efficiency assessment module 1116. In an illustrative and non-limiting embodiment, the attributes 1510 include instructions to maximize or enforce a defined cell capacity 1504, maximize revenue 1506 from cells sales and grid-scale arbitrage, and minimize cell degradation 1508. Other attributes may include, for example, a defined cost efficiency of cells of the large-scale energy storage facility, a defined amount of capacity available in the entire large-scale energy storage facility to store energy and a defined a large-scale energy storage facility revenue at a specified time.

In an embodiment, maximizing cell capacity 1504 may maximize cell lifetime. Maximizing life may comprise maximizing the health of cells i.e., a cell's capability to discharge current. By observing an increase in a battery's impedance, the energy management system 514 of an autonomous energy storage tower may cause a change in the maximum current of the cells to avoid overheating or “over-stressing” the cells to maximize the life of the cells. Thus, a defined discharge power may be determined to complement the state of health of the cells. In the embodiment, impedance may be measured based on a discharge and recharge of cells in a quality assessment process and a comparison of the discharge parameters and recharge parameters to an ideal standard, wherein the cells may be graded in a SOH grading operation. The cells 510 may be graded, for example, as A, B, C, D, and E, with A representing a high SOH and E representing a low SOH. Thus, in the embodiment, all modules with cells 510 that are graded D and E may be operated by the power control module at a C-rate of, for example, C/10, and modules having cells that are graded B and C may be operated at a C-rate of, for example, of C/5 and modules with cells 510 that are graded A may be operated at a C-rate of, for example, C/3, the C-rates being a discharge power limit of the respective cell arrays 508. The efficiency assessment module 1116 may keep learning and adjusting according to these limits in conjunction with the safety and capacity attributes. Thus, if one cell 510 graded A and cell array is taken offline because of a safety issue, another cell 510 may be operated to be upgraded from B to A keep in line with a quality demand.

Thus, maximizing capacity recognizes an impedance problem of a cell. For a cell having a high impedance, the efficiency assessment module 1116 may operate the corresponding cell array at the lowest C-rate, providing energy over the longest time.

Thus, in an illustrative embodiment, the efficiency assessment module 1116 operates based on a system of merits and demerits that functions to maximize life, safety, capacity, and other attributes while also considering other external non-cellular input data.

Thus, a computer-implemented method, system or apparatus, and computer program product are provided in the illustrative embodiments for intelligent operational efficiency enhancements and other related features, functions, or operations. Where an embodiment of a portion thereof is described with respect to a type of device, the computer-implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail) or other light-weight client-applications. The user does not manage or control the underlying cloud infrastructure, including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present disclosure may be a system, a method, and/or a computer program product at any possible technical detail level of integration. The computer program product may include the computer-readable storage medium (or media) having the computer readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, including but not limited to computer-readable storage devices as used herein, is not to be construed as being transitory signals per se, such as radio waves or other freely propagating electromagnetic waves, electromagnetic waves propagating through a waveguide, or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer-readable program instructions for storage in a computer-readable storage medium within the respective computing/processing device.

The computer-readable program instructions for carrying out operations of the present disclosure may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, to perform aspects of the present disclosure.

Aspects of the present disclosure are described herein concerning flowchart illustrations and/or block diagrams of methods, apparatus (systems), and computer program products according to embodiments of the disclosure. It will be understood that computer readable program instructions can implement each block of the flowchart illustrations and/or block diagrams and combinations of blocks in the flowchart illustrations and/or block diagrams.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. An autonomous energy storage tower comprising:
a plurality of cells configured as one or more cell arrays having a temporary no-weld architecture;
a power conversion module configured to electrically couple the autonomous energy storage tower to a grid and to an energy source,
wherein the power conversion module is configured to, responsive to completion of a SEI (solid electrolyte interface) layer formation process of the cells, receive electrical energy from the energy source or grid and to selectively supply said electrical energy to one or more of the plurality of cells in a charging mode;
wherein the power conversion module is further configured to, responsive to completion of a SEI (solid electrolyte interface) layer formation process of the cells, selectively retrieve electrical energy from one or more of the plurality of cells to supply said electrical energy to the grid or the energy source in a discharging mode,
wherein the temporary no-weld architecture comprises a temporary cell array electronic circuit configured to connect to cell terminals without a permanent connection.

2-3. (canceled)

4. An autonomous energy storage tower of claim 1, wherein the power conversion module comprises a bi-directional AC-DC converter and/or a bi-directional DC-DC converter.

5-6. (canceled)

7. The autonomous energy storage tower of claim 1, wherein the plurality of cells are configured as a plurality of cell arrays and the plurality of cell arrays are stacked onto one another,
wherein the temporary cell array electronic circuit has one or more compression devices configured to provide a temporary connection between the temporary cell array electronic circuit and terminals of the cells in the cell array.

8-10. (canceled)

10. The autonomous energy storage tower of claim 1, wherein each cell array provides an energy output of between 10 kWh to 20 kWh and the autonomous energy storage tower provides energy of 50 kWh-500 kWh.

11-13. (canceled)

14. The autonomous energy storage tower of claim 1, further comprising:
an energy management system configured to optimize the charging and discharging of the plurality of cells.

15. The autonomous energy storage tower of claim 1, wherein
the plurality of cells comprises cells having two or more distinct cell chemistries.

16. (canceled)

17. A large-scale energy storage facility comprising:
at least one autonomous energy storage tower comprising:
a plurality of cells configured as one or more cell arrays having a temporary no-weld architecture;
a power conversion module configured to electrically couple the autonomous energy storage tower to a grid and to an energy source,
wherein the power conversion module is configured to, responsive to completion of a SEI (solid electrolyte interface) layer formation process of the cells, receive electrical energy from the energy source or grid and to selectively supply said electrical energy to one or more of the plurality of cells in a charging mode;
wherein the power conversion module is further configured to, responsive to completion of a SEI (solid electrolyte interface) layer formation process of the cells, selectively retrieve electrical energy from one or more of the plurality of cells to supply said electrical energy to the grid or the energy source in a discharging mode,
wherein the temporary no-weld architecture comprises a temporary cell array electronic circuit configured to connect to cell terminals without a permanent connection.

18-19. (canceled)

20. The large-scale energy storage facility of claim 17, wherein the large-scale energy storage facility is configured to store 1-20 GWh of energy storage.

21. (canceled)

22. The large-scale energy storage facility of claim 17, wherein the large-scale energy storage facility comprises a plurality of autonomous energy storage towers and the large-scale energy storage facility is operated by tower-by-tower cycling of cells of the autonomous energy storage towers to provide energy to the grid.

23-24. (canceled)

25. The large-scale energy storage facility of claim 17, wherein the large-scale energy storage facility is configured to inventory both cells having a low cycle life, high energy density chemistry and cells having a high cycle life, low energy density chemistry.

26. A method comprising:
providing a large-scale energy storage facility comprising a plurality of manufacturing stations;
selectively storing energy from an energy source or grid as reserve energy by providing to at least one cell of a plurality of cells disposed in one or more energy storage towers the energy, said selectively storing step being performed during an inventorying stage of a manufacturing process of the at least one cell, the energy further serving as energy for a quality assessment charge cycle of the at least one cell;
selectively retrieving the reserve energy for provision to the grid or energy source by discharging energy from the at least one cell during a quality assessment discharge cycle;
obtaining cell parameter information about the at least one cell during the quality assessment charge cycle and/or discharge cycle; and
grading a quality of the at least one cell during a cell quality assessment process of the inventorying stage based on the obtained cell parameter information.

27. The method of claim 26, further comprising:
performing the cell quality assessment process on the at least one cell for a computed period of time after which the at least one cell is removed and packed into a battery pack to complete said manufacturing process.

28. The method of claim 26, wherein the at least one cell is categorized into one of a plurality of performance bins based on the graded quality, wherein cells having a same or substantially the same grade are indicated to belong to a same performance bin.

29-32. (canceled)

33. The method of claim 26, wherein the at least one cell of the plurality of cells has a high cycle life, low energy density chemistry and at least one other cell of the plurality of cells has a low cycle life, high energy density chemistry.

34-48. (canceled)

49. The method of claim 26, further comprising:
introducing one or more new cells of the plurality of cells to the large-scale energy storage facility and removing one or more existing cells of the plurality of cells from the large-scale energy storage facility in a first-in-first-out manner,
wherein said energy is selectively stored in the one or more new cells via corresponding charging cycles of the one or more new cells, and
wherein said energy is selectively retrieved from the one or more existing cells via corresponding discharge cycles of the one or more existing cells.

50. The method of claim 49, wherein the selectively storing or selectively retrieving energy is based on information selected from a list consisting of: data about a transmission, congestion data, a frequency modulation, a flow of power to the grid, an environmental weather condition, an energy input into the large-scale energy storage facility, a required cell lifetime, a required cell-end-of-manufacturing capacity, a maximum cell-end-of-manufacturing degradation, and a cell chemistry.

51-56. (canceled)

57. The method of claim 26, further comprising:
independently measuring parameters of one or more of the plurality of cells
generating input data using the parameters;
extracting one or more features from the input data, the one or more features representative of a characteristic of a request for completing an operational efficiency enhancement proposal operation, and
proposing, using the efficiency assessment module, at least one operational efficiency enhancement proposal for the subject large-scale energy storage facility;
wherein the efficiency assessment module operates as a machine learning engine.

58. The method of claim 57, further comprising:
generating, by attributes prioritization, a set of attributes of the subject large-scale energy storage facility to enforce and proposing the at least one operational efficiency enhancement proposal based on one or more attributes of the set of attributes;
wherein the attributes include at least one attribute selected from a list consisting of: a maximum cell degradation at an end-of-manufacturing time, a cell capacity at the end-of-manufacturing time, a cost efficiency of cells of the large-scale energy storage facility, an amount of capacity available to store energy, and a large-scale energy storage facility revenue at a specified time.

59-73. (canceled)

74. The computer-implemented method of claim 57, further comprising:
operating one or more of the plurality of cells, one or more of the plurality of energy storage towers and/or one or more mobile drive units of the one or more energy storage towers based on the operational efficiency enhancement proposal; and/or
manufacturing one or more cells based on the operational efficiency enhancement proposal.

75-80. (canceled)

81. A method comprising:
selectively storing energy from an energy source or grid as reserve energy by providing to at least one cell of a plurality of cells disposed in one or more energy storage towers the energy, the energy further serving as energy for a quality assessment charge cycle of the at least one cell;
selectively retrieving the reserve energy for provision to the grid or energy source by discharging energy from the at least one cell during a quality assessment discharge cycle;
obtaining cell parameter information about the at least one cell during the quality assessment charge cycle and/or discharge cycle; and
using a machine learning engine, grading a quality of the at least one cell during a cell quality assessment process of the inventorying stage based on the obtained cell parameter information.

82-106. (canceled)
